(19) United States
(12) Patent Application Publication
(10) Pub. No.: US 2006/0229917 A1
(43) Pub. Date: Oct. 12, 2006

(54) Modifiable summary of patient medical data and customized patient files

(76) Inventors: Steven John Simske, Fort Collins, CO (US); Daniel Robert Blakley, Philomath, OR (US); Tong Zhang, San Jose, CA (US); Henry W. Sang JR., Cupertino, CA (US); Herkimer Gottfried, Corvallis, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/103,677

(22) Filed: Apr. 12, 2005

(51) Int. Cl. G06F 19/00; G06F 3/00

(52) U.S. Cl. 705/3; 715/744

(57) ABSTRACT

A method for generating a modifiable summary of medical data derived from a patient can comprise steps of selecting a subset of medical data from a medical database, wherein the subset at least partially is uniquely associated with an individual patient, and generating a living graphical representation from at least a portion of the subset. The living graphical representation can be dynamically reconfigurable upon modification of the portion. In another embodiment, a method for customizing patient medical information for presentation to a patient as a customized file can comprise steps of determining a medical condition of a patient, identifying static data related to the medical condition, and identifying dynamic data uniquely related to the patient. Additional steps can include forming a customized file of the patient from the static and dynamic data, wherein the customized file summarizes at least an episode of medical care.

### FIELD OF THE INVENTION

The present invention relates generally to methods for presenting medical data derived from a patient. More particularly, the present invention relates to i) methods for generating a modifiable summary of medical data derived from a patient, and ii) methods for customizing patient medical information for presentation to a patient as a customized file.

### BACKGROUND OF THE INVENTION

Many problems associated with medical data and information exist in the current hospital system that directly impact health care providers and patients. Vast amounts of medical data are often collected from an individual patient. Doctors and other medical professionals may find it difficult to thoroughly analyze such large volumes of data. This limitation may cause the medical professional to provide the patient with a less accurate diagnosis, and thus, the level of medical care is ultimately reduced. This problem is especially pronounced in medical treatment regimens that require the monitoring of specific physiological signals. For example, the treatment of various heart problems often depends on the collection and subsequent analysis of electrocardiogram (ECG) signals from a patient. Large amounts of ECG signal data may be collected, depending on the length of time the patient is being monitored. It can be a monumental, time consuming task to sift through and analyze such a volume of data in order to generate a diagnosis. This problem is exacerbated by the fact that many abnormal heart rhythms that would be diagnostic in the treatment process may occur with intermittent frequency and with little predictability. As a result, these abnormal heart rhythms can be unavailable to a medical practitioner who may be examining only a limited number of ECG traces.

In addition to the difficulties inherent in examining large quantities of similar data, a medical diagnosis may be frustrated by medical data being partitioned separately. Urinalysis data, blood work-up data, radiological data, vital signs, as examples, are often printed separately and sent from different departments to be collected together in a patient chart. Medical professionals need to sort through these records to form a proper diagnosis. This process may be tedious, and the outcome is dependent on the medical professional remembering to look at each and every physiological result.

Patients on the other hand, often feel left out of the medical process because of their lack of understanding, as well as a perceived lack of communication from the health care provider. Many patients may feel that they are treated in a hospital or other medical facility and subsequently discharged with little understanding of what happened, what they can expect in the near future, and how they should follow up on their own recovery. They may also feel that any information that is given to them is unintelligible, and further, they may be confused as to what actions they should take if problems or concerns arise.

It would be useful to develop methods of presenting medical data to medical professionals that reduced the time required to reach a diagnosis, even in situations where there exists large amounts of physiological data. It would also be useful to provide medical information to patients in a customized format that allows greater patient comprehension.

### SUMMARY OF THE INVENTION

It has been recognized that it would be advantageous to provide medical professionals with a unique, modifiable summary of patient medical data, and/or provide patients with customized information regarding their medical treatment. As such, a method for generating a modifiable summary of medical data derived from a patient can comprise steps of selecting a subset of medical data from a medical database, wherein the subset at least partially is uniquely associated with an individual patient, and generating a living graphical representation from at least a portion of the subset. The living graphical representation can be dynamically reconfigurable upon modification of the portion.

In another embodiment, a method for customizing patient medical information for presentation to a patient as a customized file can comprise steps of determining a medical condition of a patient, at least in part, from a medical history of the patient, identifying static data related to the medical condition, and identifying dynamic data uniquely related to the patient. Additional steps can include generating a template configured to receive the static data and the dynamic data, and adding at least a portion of the static data and at least a portion of the dynamic data to the template, thereby forming a customized file of the patient, wherein the customized file summarizes at least an episode of medical care. The customized file can then be provided to the patient.

In another embodiment, a method of presenting medical data derived from a patient can comprise steps of generating a modifiable summary including medical data and a medical condition of a patient, and generating a customized file from at least a portion of the modifiable summary. The modifiable summary can include a living graph and can be at least partially uniquely associated with the patient. The customized file can include static data related to the medical condition and dynamic data uniquely related to the patient.

Additional features and advantages of the invention will be apparent from the following detailed description which illustrates, by way of example, features of the invention.

### DETAILED DESCRIPTION OF THE PREFERRED EMBODIMENTS

Before particular embodiments of the present invention are disclosed and described, it is to be understood that this invention is not limited to the particular process and materials disclosed herein as such may vary to some degree. It is also to be understood that the terminology used herein is used for the purpose of describing particular embodiments only and is not intended to be limiting, as the scope of the present invention will be defined only by the appended claims and equivalents thereof.

In describing and claiming the present invention, the following terminology will be used.

The singular forms “a,” “an,” and “the” include plural referents unless the context clearly dictates otherwise. Thus, for example, reference to “a test result” includes reference to one or more of such results.

The term “about” when referring to a numerical value or range is intended to encompass the values resulting from experimental error that can occur when taking measurements.

As used herein, “medical history” describes a collection of records describing the medical state of an individual, family history, or the like. It is to be understood the medical history may not be an accurate description of the current medical state of an individual, but is a health-related description of the individual at various points of time.

As used herein, “medical data” includes all information, both physiological and otherwise, that is collected during an episode(s) of medical care. In addition to physiological data, this category may also include hospital accounting records, baby photos, etc.

The term “static data” includes any data or information that is general to a medical condition. This being said, static data can include data or information that is specialized, but would not include data or information collected directly from the patient. For example, static data or information would include specific treatment information for a diagnosed disease, but would not include patient blood work data that lead to the diagnosis.

The term “dynamic data” includes any data or information that is specific to a patient, e.g., blood work data, urinalysis data, radiological images and data, vital signs data, photos, etc. Often the value of dynamic data is related to its time of creation and its relationship to other such data. In other words, dynamic data arises during an episode of medical care, and is often valuable due to its interrelationship with other dynamic data acquired during the same episode.

The terms “format data” and “presentation data” can be used interchangeably, and include any non-medical data or information that is included in the template. Presentation data may include branding information from a medical provider, the creator of the template, or other party associated with the medical care. Presentation data may also include formatting information related to the layout of the template, including placement of the static and dynamic data.

With these definitions as background, it is known that medical professionals often have a difficult time evaluating large amounts of medical data in a reasonable amount of time in order to provide patients with an accurate diagnosis. Patients, on the other hand, often struggle to understand medical experiences and are often confused as to what will happen to them once they have returned home. Embodiments of the present invention may alleviate these issues by providing medical professionals with a unique, modifiable summary of patient medical data, and/or by providing patients with customized information regarding their medical treatment.

In accordance with one embodiment of the present invention, a method for generating a modifiable summary of medical data derived from a patient can comprise steps of selecting a subset of medical data from a medical database, wherein the subset at least partially is uniquely associated with an individual patient, and generating a living graphical representation from at least a portion of the subset. The living graphical representation can be dynamically reconfigurable upon modification of the portion.

In another embodiment, a method for customizing patient medical information for presentation to a patient as a customized file can comprise steps of determining a medical condition of a patient, at least in part, from a medical history of the patient, identifying static data related to the medical condition, and identifying dynamic data uniquely related to the patient. Additional steps can include generating a template configured to receive the static data and the dynamic data, and adding at least a portion of the static data and at least a portion of the dynamic data to the template, thereby forming a customized file of the patient, wherein the customized file summarizes at least an episode of medical care. The customized file can then be provided to the patient or other interested party, e.g., insurance, family members, etc.

The above two embodiments can be embodied as described above, or alternatively, can be embodied such that generation of a modifiable summary for a medical professional can be combined with the generation of a customized file for the patient. For example, a method of presenting medical data derived from a patient can comprise steps of generating a modifiable summary including medical data and a medical condition of a patient, and generating a customized file from at least a portion of the modifiable summary. The modifiable summary can include a living graphical representation and can be at least partially uniquely associated with the patient. The customized file can include static data related to the medical condition and dynamic data uniquely related to the patient.

Methods for Generating a Modifiable Summary of Medical Data

The following is a description of embodiments that can provide medical professionals with a unique, modifiable summary of patient medical data. As stated, this method can include steps of selecting a subset of medical data from a medical database, where the subset of medical data is at least partially uniquely associated with an individual patient, and generating a living graphical representation from at least a portion of the subset of medical data. The living graphical representation can be dynamically reconfigurable upon modification of the portion of the subset of medical data associated with the patient.

The step of selecting a subset of medical data from a medical database can be varied based on a particular situation and the medical condition of the patient. It is well within the ability of one skilled in the art to make medical data selection decisions in order to generate a modifiable summary that will facilitate an accurate diagnosis. However, factors in addition to decisions by medical professionals may arise that dictate selection criteria. For example, a particular insurance provider or an insurance plan may have an influence over the presentation of the medical data present. If a procedure resulting from a diagnosis would not be covered by a particular insurance plan, the procedure would either not be included as an option, or would be notated as being a non-covered procedure. To illustrate, there may be insurance service plans that dictate extensive data storage and analysis, while others take a more minimalist approach. As an alternative example, a greater degree of data collection and analysis of information may be required for a patient with a more serious ailment compared to a patient who is relatively healthy. Further, selection criteria can also be related to the medical data collected from the patient itself. For example, with ECG data, a subset of medical data could be selected based on the quality of the signal, the time of day during which the signals were taken, whether the patient was active, etc.

The selection criteria can include, as alluded to above, a plurality of categories of criteria that can be prioritized. Thus, a category with a higher priority can exhibit a greater influence on the selection of the portion of the subset of medical data than a category with a lower priority. In one embodiment, for example, a health insurance provider may be set as having highest priority in selecting the portion of the subset of medical data, followed by the decisions of medical professionals, and then by patient and signal-based conditions. The order of these categories is not intended to be limiting, but merely as an illustrative example of the prioritization of specific categories. Embodiments may also contain categories whereby an event may trigger an increase in the priority of a category. The trigger may have an active and an inactive state, whereby the priority of the category is increased when the trigger is in the active state. For example, specific patient assays (e.g. urinalysis, ECGs, running stress tests, etc.) may indicate the need for a different level of data analysis, irrespective of the medical data selection criteria of a heath insurance provider.

A living graphical representation describes a method of presenting data that is interactive with a user, or that is, in other words, dynamically reconfigurable. In one embodiment, a graphical representation is said to be dynamically reconfigurable when, usually due to interaction by a user, a portion of a graph is modified or reconfigured, and those affected areas of the graph are updated with the changes. As an example, a summary of medical data may be presented to a medical professional in the form of a living graphical representation, which may include ECG graphs, bar graphs of vital signs, etc. If the medical professional desires to examine another portion of medical data, another ECG lead or different time period for the same lead, for example, an action can be taken on the living graphical representation. This action causes the summary of the medical data to be updated according to the needs of the medical professional.

In another embodiment, the living graphical representation provides a medical professional with an adaptable means of progressing from summary data to deeper diagnostic data. For example, physiological data summarized as a living graphical representation in the form of a living pie chart allows a medical professional to interact with a living pie chart to examine the data underlying the summary. If the data was heart rate, for example, a medical professional can interact with a portion of the living pie chart to examine ECG recordings related to that portion. If the portion selected was increased heart rate, interaction with that section may allow the medical professional to examine ECG recordings from periods of increased heart rate. As such, living graphical representations allow the medical professional to more quickly sift through large amounts of medical data.

An action taken on the living graphical representation to cause a change in the displayed summary can cause a modification of the portion of the subset of medical data currently being displayed. In one embodiment, the modification of the portion of the subset of medical data can be accomplished by broadening the portion of the subset. In another embodiment, the subset of the portion of medical data can be accomplished by narrowing the portion of the subset. In yet another embodiment, the modification of the portion of the subset of medical data can be accomplished by shifting the portion of the subset to include additional medical data of the subset in a first area, and less medical data of the subset in a second area. In the latter embodiment, for example, if a medical professional is examining morning ECG data from a patient and desires to see afternoon ECG data, appropriate action (clicking, voice activation, menu activation and selection, etc.) on the living graphical summary will cause an alternate portion of the subset of medical data to be displayed, thus constituting a modification of the portion.

The living graphical representation can also include multiple types of medical data that are interactively linked. For example, when a user takes an action to view ECGs collected during a time period not displayed on the living graphical representation, graphs displaying vital signs may be updated to correspond to the time period during which the now displayed ECGs were collected.

A living graphical representation can also be dynamically reconfigurable such that medical data is presented in a form that is not present in the medical database. For example, the medical database may contain ECG data collected from the patient over a period of time. As a diagnostic aid to the medical professional, ECG data may be converted to vectorcardiogram (VCG) data and displayed by means of the living graphical representation. Any other transformation known to one skilled in the art would be considered within the scope of the present invention.

In one embodiment of the present invention, the living graphical representation can be displayed on an electronic display. This display may be a desktop computer, a laptop computer, a tablet PC, a handheld PC, or any other electronic display device known to one skilled in the art. The electronic display may allow a medical professional to point to or click on a selection of displayed medical data with a mouse or by means of a touch screen to facilitate a modification of a portion of the subset of medical data. The modification would result in a rapid update of the medical data displayed in the living graphical representation.

In another embodiment of the present invention, the living graphical representation can be printed on tangible print media. The print media can be paper, transparency, photobase, or any other form of print media known to one skilled in the art. The modification of the portion of the subset of medical data can be accomplished by noting, such as with a marking device, an intended modification of the portion on the tangible print media to form altered tangible print media. The notation may be by means of a highlighter, a pen, pencil, or any other means of marking print media. The altered tangible print media can then be introduced into the medical database in an electronic form. This may be accomplished by any means known to one skilled in the art, such as scanning or digitally photographing. The differences between the living graphical representation and the altered tangible print media can then be noted electronically. This may be accomplished by performing a pixel-by-pixel comparison after registering, or aligning, the two images. A region of the portion of the subset of medical data containing notation is then modified to coincide with the notation, and the living graphical representation is updated to coincide with the modification. A copy of the modified living graphical representation can then be printed and utilized by the medical professional.

Methods for Customizing Patient Medical Information in the Form of a Customized File

The following is a description of embodiments of the present invention that can provide patients with a unique, customized file with information regarding their medical treatment. One embodiment provides a method for customizing patient medical information for presentation to a patient as a customized file. The method can include steps of determining a medical condition of a patient, at least in part, from a medical history of the patient, identifying static data related to the medical condition, and identifying dynamic data uniquely related to the patient. Other steps include generating a template configured to receive the static data and the dynamic data, adding at least a portion of the static data and at least a portion of the dynamic data to the template, thereby forming a customized file of the patient, where the customized file summarizes at least an episode of medical care, and providing the patient or interested party with a copy of the customized file. In certain circumstances, the step of providing the patient with a copy of the customized file can include providing the family of the patient or another authorized party a copy of the customized file.

The customized file is intended to provide a patient with information regarding an episode of medical care. The customized file can include information generally related to the patient's medical condition, and can further include personalized information uniquely related to the patient and his or her experience. By providing both of these types of information collected together into one customized file, it is hoped that the patient will have a better understanding of his or her medical history. The customized file is also intended to comply with the wishes of medical care providers. Various manifestations of customized files may include electronic copies, as well as printed physical manifestations such as brochures, catalogs, books, and other printed documents that can manifest branding and formatting consistent with these wishes. As such, in one embodiment, the patient can be provided with a substantial amount of customized medical information from an episode of medical care in the form of a single book or brochure. In one embodiment of the present invention, an episode of medical care may be used to describe a single treatment, a particular stay with a health care provider, or the extended treatment of an illness or condition. Examples of treatments and/or illnesses or conditions may include, without limitation, appendicitis, cancer treatment, heart monitoring and/or treatment, radiological tests such as NMR and MRI scans, pregnancy, child birth, etc.

In one embodiment, an episode of medical care is a past episode of medical care. In other words, the patient has already received the medical care, and the customized file may include information regarding what occurred in the episode, and possibly what the patient can expect in the near future, what warning signs to watch for, and who to contact if problems arise. The information may include in-depth medical advice, which may involve a description of the patient's symptoms as recorded by relevant physiological sensors, recordings or images from the patient, an overview of the pathology and progression of their ailments, etc. As an example, a patient who has just given birth will receive a customized file explaining what occurred, both generally in child birth and those specific issues that are uniquely related to that patient, e.g., baby photos, baby and mother ECGs, etc., along with more general information explaining how to care for the infant, what warning signs to watch for, and who to contact with concerns regarding the baby's health.

In another embodiment, an episode of medical care can be an upcoming episode of medical care. In other words, the patient may have already received a diagnosis, but the medical care may occur in the future, whether scheduled or not. In this case, the customized file may include information regarding what will occur in the episode, and possibly what the patient can do during and following the procedure, what warning signs to watch for that may require acceleration of the procedure schedule, and who to contact if problems arise. As an example, a patient who is pregnant will receive a customized file explaining what will occur during the birthing process, both generally in child birth and those specific issues that may be uniquely related to that patient, e.g., if the patient has diabetes, possible Rh factor issues, etc., and explaining how to prepare for the birth, what warning signs to watch for, and who to contact with concerns regarding the mother's health. In addition to this static data related generally to the medical conditions, dynamic data can also be included, such as ultrasounds, blood test results, etc.

Other embodiments may also provide a customized file or catalog to a patient that includes medical information from the diagnosis of the medical condition through recovery. The customized file may also include a section describing preparation for a given procedure, a record of a patient stay in a medical facility, and information regarding subsequent recovery and contact information. In this manner, the customized file can be targeted to important portions of the medical care lifecycle, such as the preparation phase, the hospitalization phase, and the post-hospitalization phase.

A medical condition describes a general category of all medical reasons a patient has for seeking medical help. Determining a medical condition of a patient may be based on past medical history, and/or it may be based on a diagnosis related to an upcoming medical procedure or planned medical care. Upon knowing a medical condition, static data can be chosen that is related to that condition.

Static data is medical data or information that is related to a medical condition. It may be in textual form, graphical form, or both. This information may be customized to some extent by a medical professional to take into account the level of knowledge of the patient. Static data may be information from medical journals, medical texts, medical reference materials, information from societies such as the American Heart Association, drug information from a pharmaceutical company or a medical reference such as the PDR, related medical equipment information, e.g., a Holter device, or any other source of information known to one skilled in the art.

As an example intended only to be descriptive and not limiting, static data from childbirth may include general newborn care, emergency care, information on diet, weight, height, cognitive development, what to expect as the child develops, etc. As another example, static data from heart surgery may include general surgical information, heart physiology, drug information, general anatomical and physiological information, charts on height, weight, gender data, etc. In other words, static data is intended to include any general medical information that may be relevant to the medical condition of the patient.

The static data category can also include general information related to the health care provider. For example, the customized file may contain public relations information from the hospital, information on specific physicians and nurses that assisted the patient, etc. The static data category can also include information related to an insurance provider or the provider of the customized file. This information may also be public relations material, advertising material, or information specifically related to a patient insurance plan and how the medical episode may be covered. Also, branding may be included in the customized file from any of the above sources, such as hospital or insurance logos or trademarks.

Dynamic data, on the other hand, is medical data or information that is uniquely related to a patient. It may be in textual form, graphical form, or both. This information can also be customized to some extent by a medical professional to take into account the level of knowledge of the patient. Dynamic data may be information from medical tests, radiological images or data, instructions regarding aspects of the medical condition that are unique to the patient, instructions related to additional patient factors that are not normally associated with the medical condition, e.g., how diabetes may relate to a different condition, etc. It is intended that dynamic data include any relevant information uniquely related to the patient. In one embodiment, a medical professional may identify dynamic data for inclusion in the customized file that may be of use to the patient. In another embodiment, the patient may approve at least a portion of the dynamic data for inclusion in the template, and thus, ultimately, the customized file. This may allow patients some discretion to choose areas of their medical data from which they may want more information, and to discard those areas for which they have little interest.

As an example intended only to be descriptive and not limiting, dynamic data from childbirth may include photos from the childbirth, hospitalization, etc. Photos and other related information can be customized as to the number, size, and content. Other examples of dynamic data from childbirth include specific childcare instructions that may be date or time specific requiring particular attention, e.g., scheduling of follow up matters for a premature birth, gender-based and single-parent considerations which includes unique information, dates to return for checkups, etc. As another example, dynamic data from heart surgery may include heart images, scans, ECG's, other biological signals, patient symptoms, diagnosis, medication regimen, etc. In other words, dynamic data is intended to include any relevant information that is uniquely related to the patient, but does not include merely specialized static information.

The customized file can be provided to the patient in a number of formats. In one embodiment, the customized file can be provided as a printed copy. As an example, the customized file may be printed as a template utilizing variable data printing (VDP). With VDP, a template can be prepared with static data and “holes” for the dynamic data. The dynamic data is inserted into the holes and the template is printed, and a copy given to the patient. This would allow the patient to take a physical copy home to keep.

In another embodiment, the customized file can be provided to the patient as an electronic copy. This copy may be burned on a compact disk or other computer media, or it may be stored on a server and access given to the patient using an internet address. The internet may be on the World Wide Web, on a local area network, or on any other type of network known to one skilled in the art.

It is to be understood that the above-referenced arrangements are illustrative of the application for the principles of the present invention. Numerous modifications and alternative arrangements can be devised without departing from the spirit and scope of the present invention while the present invention has been shown in the drawings and described above in connection with the exemplary embodiments of the invention. It will be apparent to those of ordinary skill in the art that numerous modifications can be made without departing from the principles and concepts of the invention as set forth in the claims.

What is claimed is:

1. A method for generating a modifiable summary of medical data derived from a patient, comprising:
selecting a subset of medical data from a medical database, said subset at least partially uniquely associated with an individual patient;
generating a living graphical representation from at least a portion of the subset, said living graphical representation being dynamically reconfigurable upon modification of the portion.

2. The method of claim 1, wherein the modification is by broadening the portion.

3. The method of claim 1, wherein the modification is by narrowing the portion.

4. The method of claim 1, wherein the modification is by shifting the portion to include additional medical data of the subset in a first area, and less medical data of the subset in a second area.

5. The method of claim 1, wherein the living graphical representation is dynamically reconfigurable such that medical data is presented in a form not present in the medical database.

6. The method of claim 1, wherein selection of the portion is at least partially based on selection criteria.

7. The method of claim 6, wherein the selection criteria is a plurality of categories of criteria.

8. The method of claim 7, further comprising prioritizing the categories of criteria, such that a category with a higher priority exhibits a greater influence on the selection of the portion than a category with a lower priority.

9. The method of claim 8, wherein a category includes a trigger having an active state and an inactive state, said trigger increasing the priority of the category when in the active state.

10. The method of claim 7, wherein the categories of criteria includes an insurance decision category.

11. The method of claim 7, wherein the categories of criteria includes a medical decision category.

12. The method of claim 7, wherein the categories of criteria includes a data decision category.

13. The method of claim 1, wherein the living graphical representation is displayed on an electronic display.

14. The method of claim 13, wherein the modification of the portion is facilitated by user interaction with the electronic display.

15. The method of claim 1, wherein the living graphical representation is printed on tangible print media, and the modification of the portion further comprises steps of:
noting an intended modification of the portion on the tangible print media to form altered tangible print media;
introducing the altered tangible print media into the medical database in electronic form;
electronically noting a difference between the living graphical representation and the altered tangible print media; and
modifying the living graphical representation to correspond with the difference between the living graphical representation and the altered tangible print media.

16. The method of claim 15, wherein the step of modifying the living graphical representation includes printing the living graphical representation on tangible print media.

17. A method for customizing patient medical information for presentation to a patient as a customized file, comprising steps of:
determining a medical condition of a patient, at least in part, from a medical history of the patient;
identifying static data related to the medical condition;
identifying dynamic data uniquely related to the patient;
generating a template configured to receive the static data and the dynamic data;
adding at least a portion of the static data and at least a portion of the dynamic data to the template, thereby forming a customized file of the patient, wherein the customized file summarizes at least an episode of medical care; and
providing the patient or interested party with a copy of the customized file.

18. The method of claim 17, wherein the step of identifying dynamic data is carried out by a medical professional.

19. The method of claim 17, wherein the episode of medical care is a past episode of medical care.

20. The method of claim 17, wherein the episode of medical care is an upcoming episode of medical care.

21. The method of claim 17, wherein the step of identifying static data includes identifying static information selected from the group consisting of, information related to a health care provider, information related to an insurance provider, information related to a customized file provider, and combinations thereof.

22. The method of claim 17, wherein at least a portion of either the static or the dynamic data added to the template is in graphical form.

23. The method of claim 17, further comprising the step of approving, by the patient, at least a portion of the dynamic data for inclusion in the template.

24. The method of claim 17, wherein the step of providing the patient with a copy of the customized file includes providing family of the patient with a copy of the customized file.

25. The method of claim 17, wherein the customized file is provided to the patient as a printed copy.

26. The method of claim 17, wherein the customized file is provided to the patient as an electronic copy.

27. The method of claim 26, wherein the electronic copy is accessible using an internet address.

28. The method of claim 17, further comprising steps of selecting presentation data, wherein the presentation data is utilized to generate the template.

29. The method of claim 28, wherein the presentation data includes branding information.

30. The method of claim 28, wherein the presentation data includes orientation information regarding the placement of the static data and the dynamic data within the template.

31. A method of presenting medical data derived from a patient, comprising steps of:
a) generating a modifiable summary including medical data and a medical condition of a patient, said modifiable summary including a living graphical representation and being at least partially uniquely associated with the patient;
b) generating a customized file from at least a portion of the modifiable summary, said customized file including static data related to the medical condition and dynamic data uniquely related to the patient.

32. The method of claim 31, wherein the modifiable summary is displayed on an electronic display.

33. The method of claim 32, wherein the modifiable summary is modified by user interaction with the electronic display.

34. The method of claim 31, wherein the living graphical representation is printed on tangible print media, and modification of the modifiable summary further comprises steps of:
noting an intended modification of the living graphical representation on the tangible print media to form altered tangible print media;
producing an electronic copy of the altered tangible print media;
electronically noting a difference between the living graphical representation and the electronic copy of the altered tangible print media; and
modifying the modifiable summary to correspond with the difference between the living graphical representation and the electronic copy of the altered tangible print media.

35. The method of claim 34, wherein the modification of the modifiable summary includes printing the modifiable summary on tangible print media.
